(19) United States
(12) Patent Application Publication
(10) Pub. No.: US 2016/0006320 A1
(43) Pub. Date: Jan. 7, 2016

(54) Pendulum Type Energy-Saving Power Generation Device

(71) Applicant: YOKADA INDUSTRIAL CO., LTD., New Taipei City (TW)

(72) Inventor: Fu-Wen Chen, New Taipei City (TW)

(21) Appl. No.: 14/324,248

(22) Filed: Jul. 7, 2014

(51) Int. Cl. H02K 7/18

(52) U.S. Cl. CPC H02K 7/1892; Y10S 74/09; H02K 53/00

(57) ABSTRACT

The present invention relates to a pendulum type energy-saving power generation device, which has a structure that includes a pendulum device, a push-assisting device applying a force to maintain continuous swing of the pendulum device, and an electrical power system that stores the energy converted by the pendulum device and supplies electrical energy required for an operation of the push-assisting device. With the above-described structure, through a swing operation of the pendulum device, the energy generated by the operation is converted into necessary electrical energy that is stored in the electrical power system, with a fraction of the electrical energy being supplied to the push-assisting device to timely provide an assisting push to the pendulum device when the swing of the pendulum device is reduced by friction so as to maintain a continuous operation thereof to continuously generate electrical energy.

### (a) TECHNICAL FIELD OF THE INVENTION

The present invention generally relates to a pendulum type energy-saving power generation device, and more particularly to a pendulum type energy-saving power generation device that converts kinetic energy or potential energy of a swing device into electrical power and maintains swinging with the electrical power so as to continuously accumulate energy and generate power.

### (b) DESCRIPTION OF THE PRIOR ART

One of the key factors that bring the prosperous development of the modern society is the abundance of energy supply. However, the natural resources that the Earth can supply are limited. When the natural resources, such as fossil oil, get drained, efficient use of alternative energies without causing environmental pollutions would be an important indication of economically strong countries and is surely the future way of energy storage for human living.

Some of the commonly known alternative energies, such as power plants based on solar energy, wind power, hydraulic power, and thermal power, have technical bottlenecks and limitations. For example, the solar power generation devices must be installed at sites where sunlight can be well received and may get inactive in the nighttime. The wind power generation devices must be built at sites where winds can be received and the wind speeds reach a certain level. The hydraulic power generation devices must be arranged in combination with water flows and are generally built nearby rivers or water reservoirs. These are site-related constraints for the above discussed alternative power generation devices. The thermal power generation devices pose severe damages to the environment and consume mineral resources.

In addition to the above-mentioned power generation facilities, nuclear power generation is also commonly used. However, recently, it is frequently known of the hazard events of environment and human beings resulting from disasters of nuclear power generation. Thus, the authorities are recently seeking for other ways of power generation to substitute the nuclear power generation.

The above-discussed solutions of power generation apparently pose the following problems and drawbacks that must be overcome:

(1) The conditions of installation are severe and are readily affected by weather and thus, the power generation performance is unstable and continuous generation of power becomes impossible and environmental pollution may result.

(2) They are built outdoors and are subjected to damage due to exposure to wind and sunlight so that deterioration is quick. Thus, the overall economic benefit is low and they are sometimes considered “expensive alternative energies”.

Thus, it is a challenge of the inventor and the manufacturers of the related fields to provide a solution for the above-discussed problems and drawbacks.

### SUMMARY OF THE INVENTION

In view of the above drawbacks, the present invention aims to provide a pendulum type energy-saving power generation device that allows for 24-hour non-interrupted generation of electrical power without great costs of installation and maintenance and can reduce overall expenditure and risk and enhance performance of power generation.

The primary object of the present invention is to make use of the characteristic of back-and-forth swing of a pendulum device and convert the energy of the movement thereof into electrical energy that is then stored in an electrical power system and applies the electrical power of the electrical power system to drive a push-assisting device to timely apply a push force to the pendulum device to maintain the swing thereof, whereby except for a minor fraction of the electrical power so converted that is consumed by the push-assisting device, the remaining electrical power is stored for subsequent use.

To achieve the above object, the present invention provides a structure that generally comprises: a pendulum device, the pendulum device comprising a push-assisting device mounted at one side thereof, the push-assisting device applying a force to the pendulum device to maintain a continuous operation of swing thereof, and an electrical power system that is electrically connected to the pendulum device and the push-assisting device to store the energy converted by the pendulum device and supplies electrical energy required for an operation of the push-assisting device. In an attempt to use the present invention, a user only needs to supply an initial potential energy to the pendulum device to allow it to naturally swing so as to convert the energy generated by the process of swing of the pendulum device into electrical energy to be stored in the electrical power system. Although the swing operation of the pendulum device will be eventually stopped by friction, the push-assisting device may provide an assisting push to the pendulum device to maintain the operation thereof by making use of the electrical energy from the electrical power system when the swing height of the pendulum device gets lowered, thereby achieving a cyclic process of energy conversion, making the present invention continuously operate to generate electrical power and store energy.

With the above-described technical solution, the problems of the conventional power generation devices that the conditions for installation thereof are severe, they are readily susceptible to influence by weather, they are easily damaged and get quick deterioration, they cannot maintain long term power generation operations, and the economic benefit is low can be overcome and the above-mentioned advantages can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is a side elevational view of the preferred embodiment of the present invention.

FIG. 3 is a structure block diagram of the preferred embodiment of the present invention.

FIG. 4 is a schematic view illustrating an operation of the preferred embodiment of the present invention.

FIG. 5 is another schematic view illustrating the operation of the preferred embodiment of the present invention.

FIG. 6 is a further schematic view illustrating the operation of the preferred embodiment of the present invention.

FIG. 7 is a flow chart illustrating a process of power generation of the preferred embodiment of the present invention.

FIG. 8 is a schematic view showing an application of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

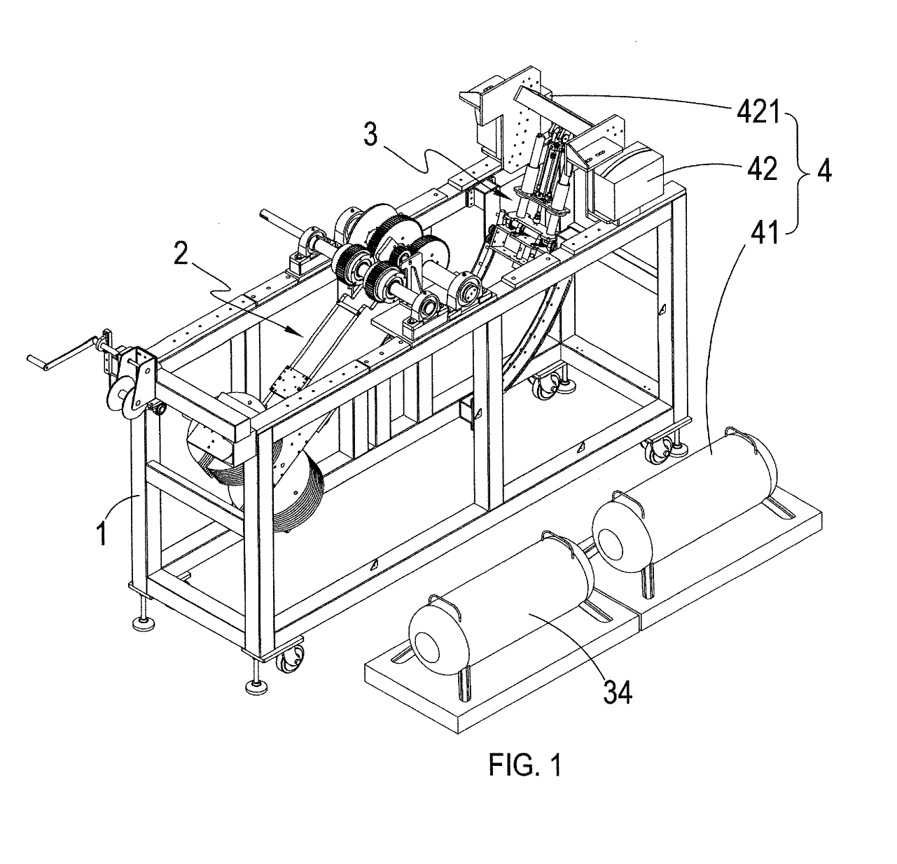

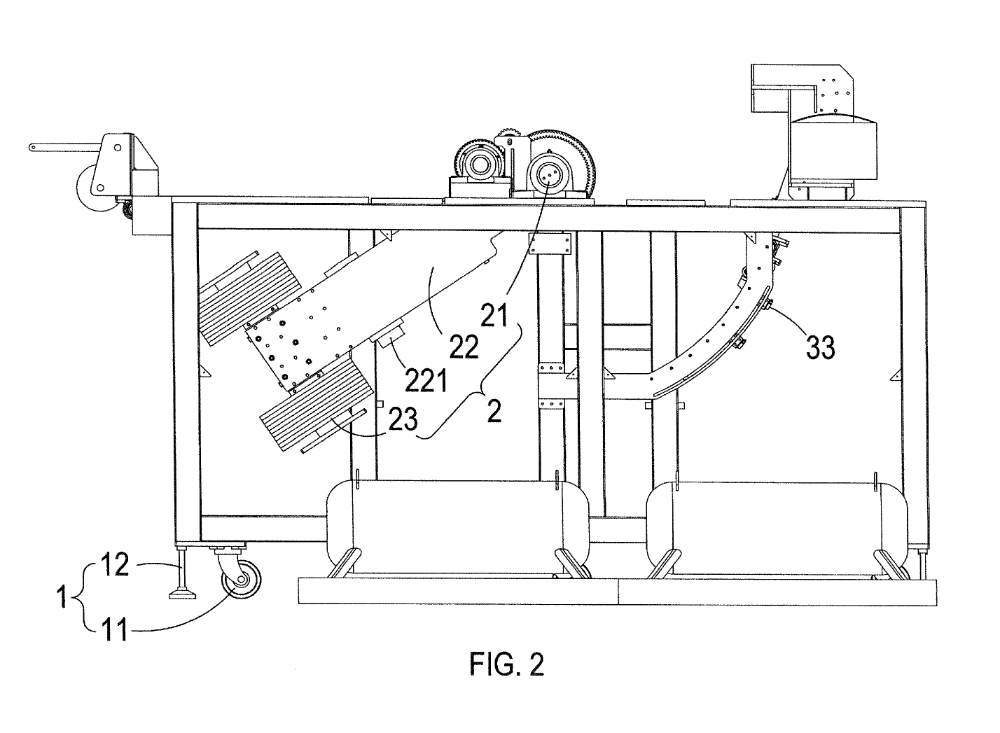

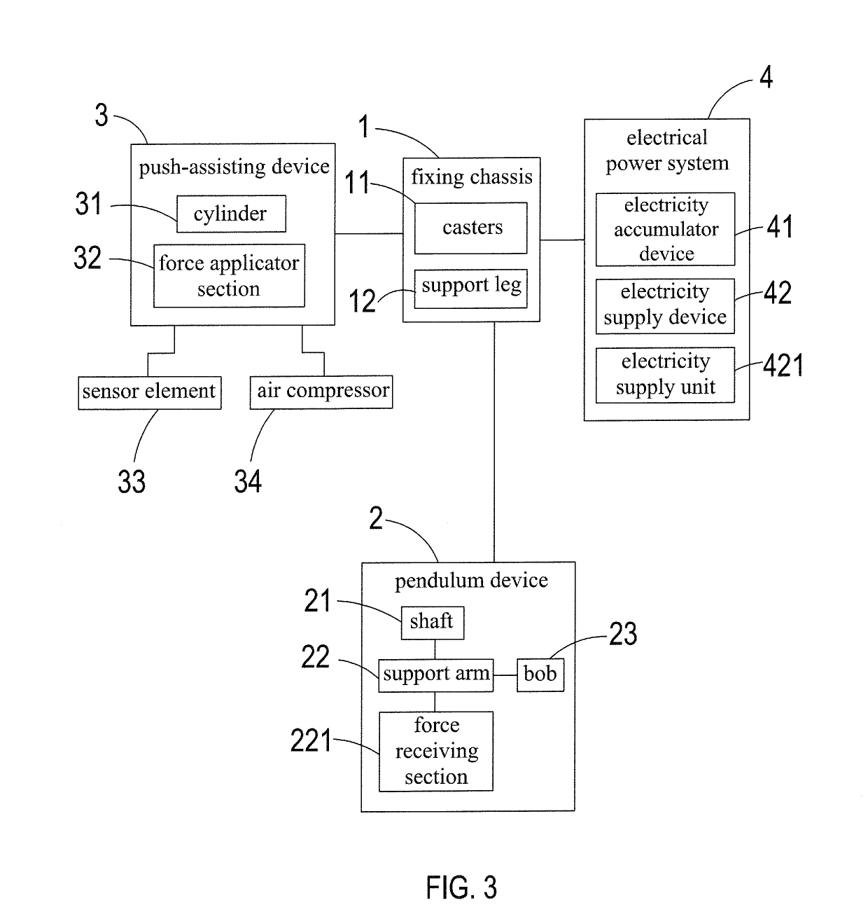

Referring to FIGS. 1, 2, and 3, which are respectively a perspective view, a side elevational view, and a structure block diagram of the preferred embodiment of the present invention, the drawings clearly show the present invention comprises:

a fixing chassis 1 that receives a pendulum device 2 that will be described hereinafter, a push-assisting device 3 that will be described hereinafter, and an electrical power system 4 that will be described hereinafter to be mounted therein. The fixing chassis 1 has a bottom that is provided with a plurality of casters 11 and at least one support leg 12;

a pendulum device 2, wherein the pendulum device 2 comprises a shaft 21 that is rotatably mounted to the fixing chassis 1, a support arm 22 that is fixedly mounted to the shaft 21, and a bob 23 that is mounted to an end of the support arm 22, in which the support arm 22 has one side on which a force receiving section 221 is mounted to receive a force applied by the push-assisting device 3 that will be described hereinafter;

a push-assisting device 3, which is mounted at beside the pendulum device 2 to apply a force to the pendulum device 2 to maintain continuous swing thereof, the push-assisting device 3 comprising at least one cylinder 31 and a force applicator section 32 corresponding to the force receiving section 221, the push-assisting device 3 comprising an air compressor 34 that is mounted to the fixing chassis 1 and electrically connected to the electrical power system 4 that will be described hereinafter and also electrically connected to at least one sensor element 33 to detect a swing height of the pendulum device 2 in order to activate the push-assisting device 3 when the height is insufficient; and

an electrical power system 4, which is electrically connected to the pendulum device 2 and the push-assisting device 3, the electrical power system 4 comprising an electricity accumulator device 41 that stores energy that is converted by the pendulum device 2 and an electricity supply device 42 that is electrically connected to the air compressor 34 and the electricity accumulator device 41, the electricity supply device 42 comprising an electricity supply unit 421 that is fixed on the fixing chassis 1 to supply electrical energy from the electricity accumulator device 41 to other facility.

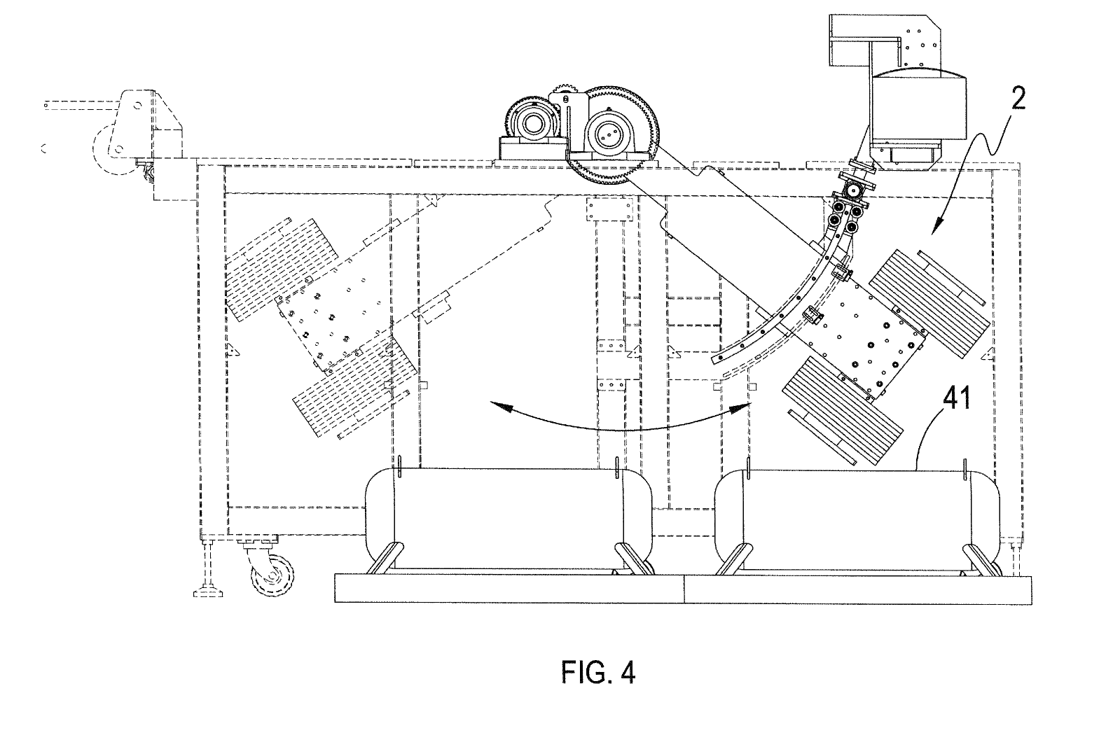

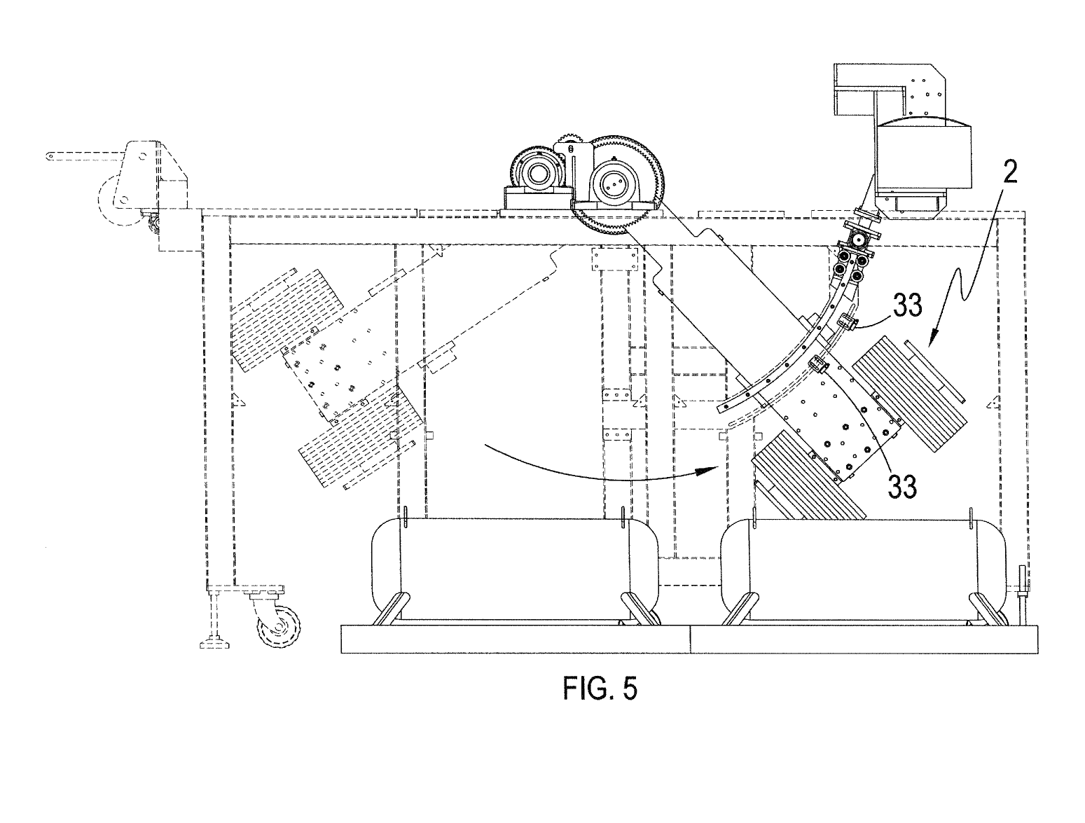

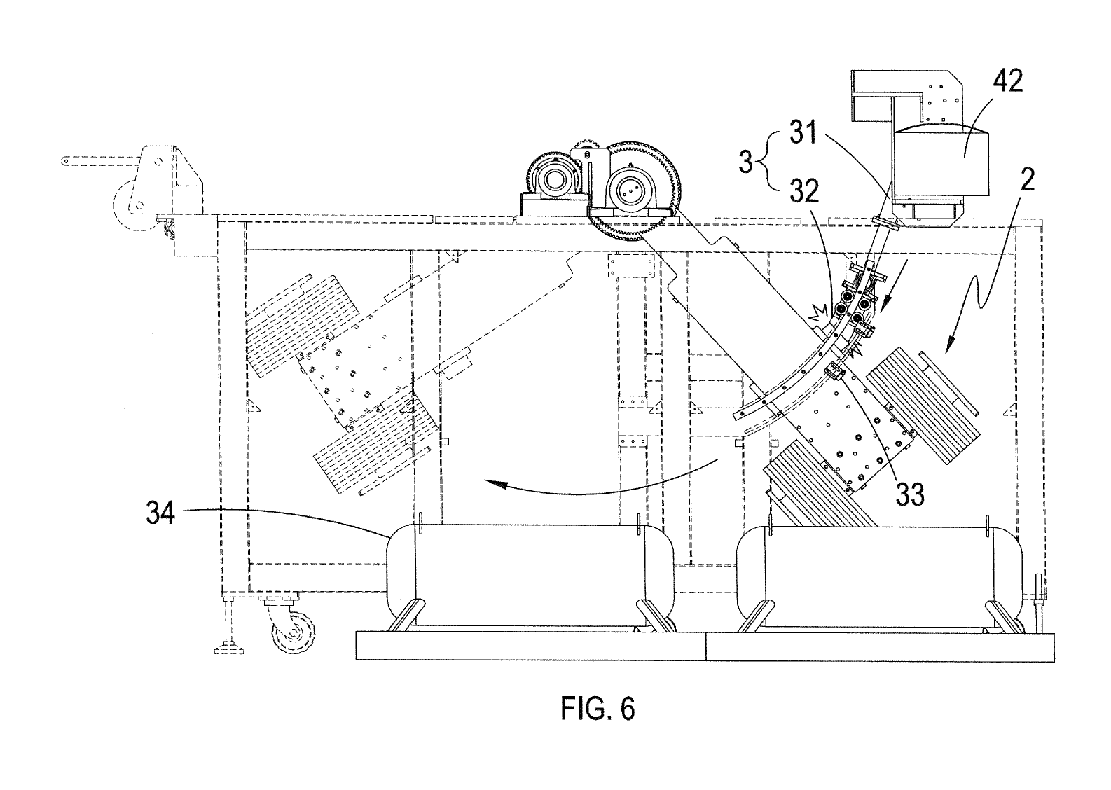

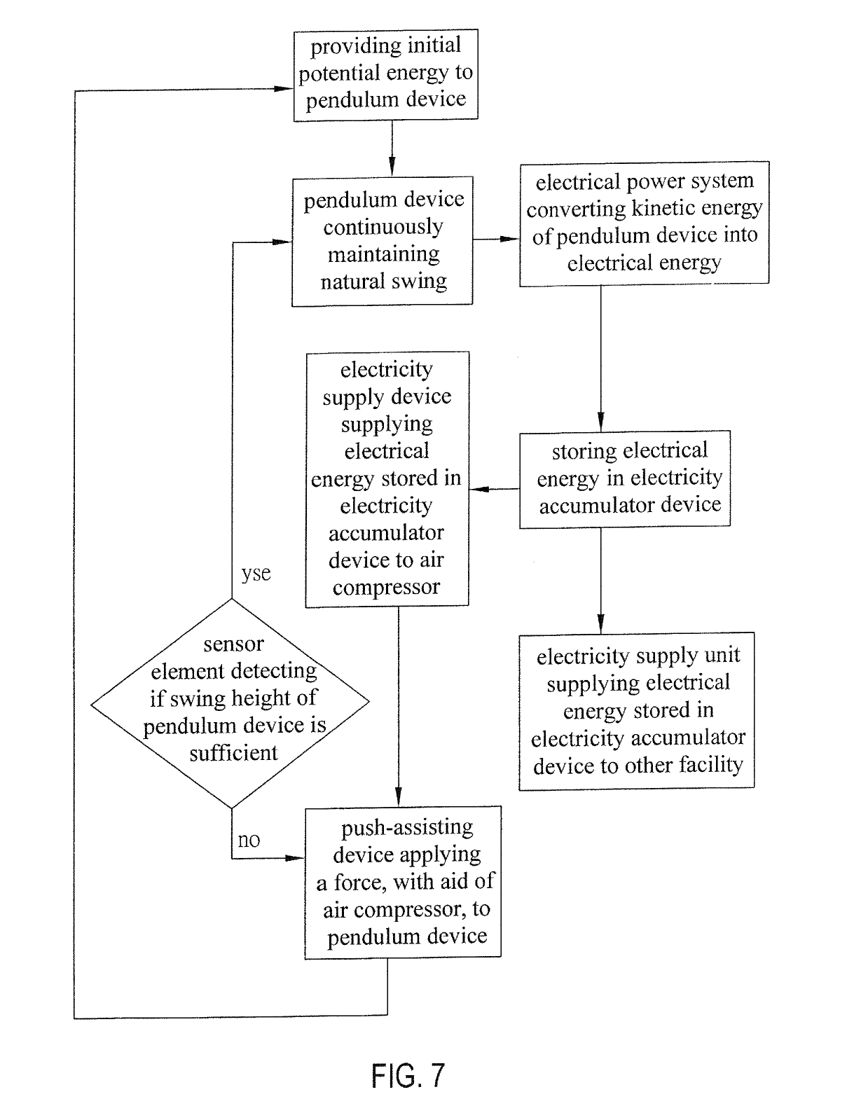

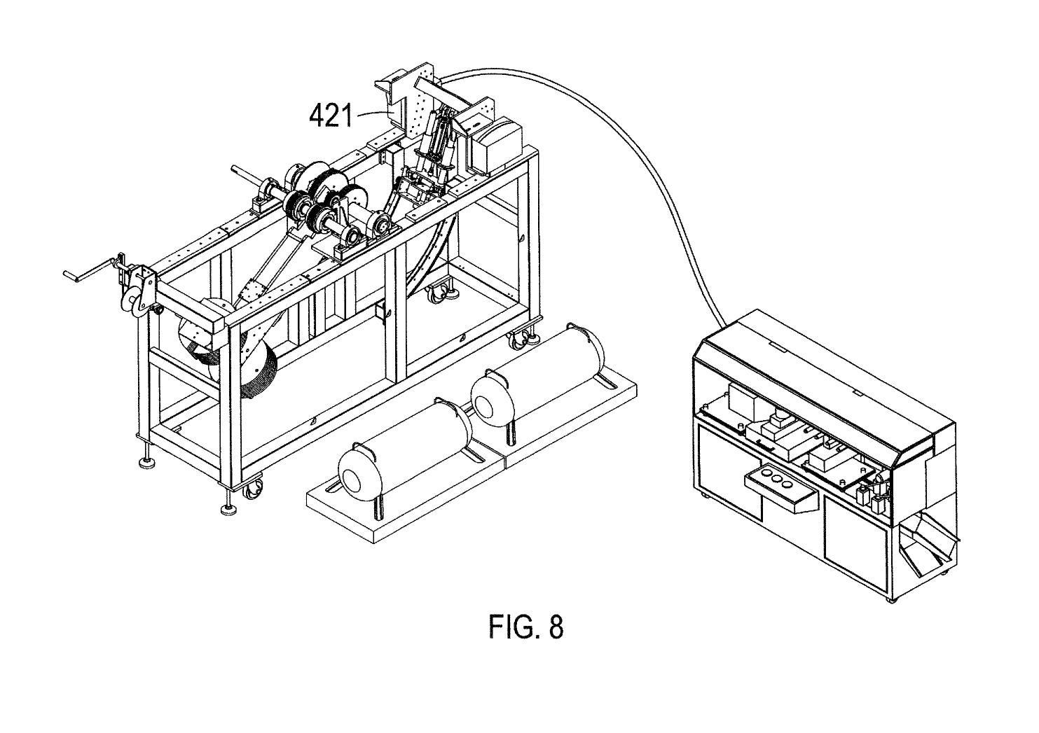

Referring to FIGS. 1-8, which are respectively a perspective view, a side elevational view, a structure block diagram of the preferred embodiment, three schematic views illustrating an operation of the preferred embodiment of the present invention, a flow chart illustrating a process of power generation of the preferred embodiment of the present invention, and a schematic view showing an application of the preferred embodiment of the present invention, these drawings clearly show that, with an assembly of the above-described components, the bottom of the fixing chassis 1 of the present invention comprises the casters 11 for moving the present invention, so that the use of the present invention is not limited to a specific site or field and can be transferred when necessary. The principle of operation of the present invention is swing and the support leg 12 is additional provided on the fixing chassis 1 to maintain overall stability of the entirety thereof for effectively achieving desired conversion of energy.

The pendulum device 2 is arranged by first rotatably mounting the shaft 21 to the fixing chassis 1 and using the support arm 22 to connect the shaft 21 and the bob 23. The weight of the bob 23 may be change to suit the needs of other facility in order to provide torques of different levels. Thus, in an actual operation, the pendulum device 2 is first giving an initial potential energy (by pushing the bob 23 to a sufficient level of height for swing) and then allowing the pendulum device 2 to swing by itself. During this process, energy generated by the swing movement is converted by the electrical power system 4 into electrical energy that is stored in the electricity accumulator device 41. However, the swing height of the pendulum device 2 is gradually reduced due to being partly canceled by the frictional force, and the sensor element 33 is arranged to detect the swing height of the pendulum device 2, whereby when it detects the swing height is lowered down to a predetermined level, the push-assisting device 3 is activated for operation. The push-assisting device 3 is composed of the cylinder 31 and the force applicator section 32 and receives a power supply from the air compressor 34, while the air compressor 34 receives electrical energy from the electricity supply device 42. The electrical energy of the electricity supply device 42 is transferred from the electricity accumulator device 41. In other words, the power supply of the push-assisting device 3 is also from the pendulum device 2, and no additional supply of electrical power is necessary. When the push-assisting device 3 is activated into operation, the force applicator section 32 is extended to contact the force receiving section 221 of the support arm 22 thereby applying a push force to maintain continuous swing of the pendulum device 2. Such a push force may be adjusted according to the torque of the pendulum device 2 in order to achieve an operation continuous swing and continuous generation of electricity, whereby the present invention may continuously supply and store electricity.

Further, the electrical energy required by the push-assisting device 3 is extremely minor and the electrical energy accumulated in the above-discussed cycles may not be just supplied to the push-assisting device 3 and can be additionally supplied to other facility by just connecting the electricity supply unit 421 to said other facility, whereby said other facility may share the electrical power generated with the present invention.

It is, however, noted that what described above is just a preferred embodiment of the present invention and is not intended to limit the scope of protection that the present invention seeks for. Simple modifications and variations of equivalent based on the above disclosure and drawings of the present invention are considered within the scope of protection of the present invention.

Thus, the key factors that the pendulum type energy-saving power generation device according to the present invention may overcome the drawbacks of the prior art are as follows:

(1) The structure is simple and is applicable both indoors and outdoors.

(2) The operation is not affected by weather and may work all the time.

(3) The electrical energy generated can be stored for subsequent use or can supplied to other facility.

(4) A structure for cyclic generation of electricity is provided, which has a great economic value and use.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A pendulum type energy-saving power generation device, comprising:
a pendulum device;
a push-assisting device, which is arranged beside the pendulum device to selectively apply a force to the pendulum device to maintain continuous swing thereof; and
an electrical power system, which is electrically connected to the pendulum device and the push-assisting device to receive and store energy converted by the pendulum device and supplies electrical energy required by an operation of the push-assisting device.

2. The pendulum type energy-saving power generation device according to claim 1 further comprising a fixing chassis in which the pendulum device, the push-assisting device, and the electrical power system are mounted.

3. The pendulum type energy-saving power generation device according to claim 2, wherein the fixing chassis has a bottom to which a plurality of caster and at least one support leg are mounted.

4. The pendulum type energy-saving power generation device according to claim 2, wherein the push-assisting device comprises an air compressor that is mounted to the fixing chassis and is electrically connected to the electrical power system.

5. The pendulum type energy-saving power generation device according to claim 4, wherein the electrical power system comprises an electricity accumulator device that stores the energy converted by the pendulum device and an electricity supply device electrically connected to the air compressor and the electricity accumulator device.

6. The pendulum type energy-saving power generation device according to claim 5, wherein the electricity supply device comprises an electricity supply unit mounted to the fixing chassis to supply electrical energy from the electricity accumulator device to other facility.

7. The pendulum type energy-saving power generation device according to claim 2, wherein the pendulum device comprises a shaft rotatably mounted to the fixing chassis, a support fixedly mounted to the shaft, and a bob mounted to an end of the support arm.

8. The pendulum type energy-saving power generation device according to claim 7, wherein the support arm comprises a force receiving section mounted to one side thereof to receive the force applied by the push-assisting device.

9. The pendulum type energy-saving power generation device according to claim 8, wherein the push-assisting device comprises at least one cylinder and a force applicator section that applies the force to the force receiving section.

10. The pendulum type energy-saving power generation device according to claim 1, wherein the push-assisting device is electrically connected to at least one sensor element, which detects a swing height of the pendulum device and activates the push-assisting device in response to insufficiency of the height.
